(19) United States
(12) Patent Application Publication
(10) Pub. No.: US 2008/0127261 A1
(43) Pub. Date: May 29, 2008

(54) METHOD AND APPARATUS FOR MAINTAINING A CACHE OF PREVIOUSLY VIEWED TELEVISION SHOWS

(75) Inventors: Shaun Ijeomah, Poughkeepsie, NY (US); Louis R. Ruggiero, Sandy Hook, CT (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,956

(22) Filed: Sep. 21, 2006

(51) Int. Cl. G06F 3/00

(52) U.S. Cl. 725/40

(57) ABSTRACT

A system for maintaining a cache of previously viewed television content, includes a processor coupled to memory for receiving an input of information in addition to the content and related to the television content as well as from the cache and providing an on-screen menu to a viewer, the on-screen menu providing fields of relevant data from at least one of the additional information and the cache and receiving input from the viewer for saving at least the additional information to the cache.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The teachings herein relate to tracking of television viewing, and in particular to maintaining a cache of previously viewed television shows.

2. Description of the Related Art

At times when viewers watch television, they surf the channel trying to find a program they like to watch. In some cases, it turns out to be a channel the viewer may have looked at three or four channels ago. Unless the viewer has a good memory, they do not remember the channel and must view the guide to determine that channel the show was on.

What is needed is a capability for at least one of a television, a cable box, a satellite box and a subscriber service to track channels previously viewed. A solution is required to provide television viewers the ability to have access to a listing containing the previous channels viewed.

### SUMMARY OF THE INVENTION

The shortcomings of the prior art are overcome and additional advantages are provided through the provision of a menu system for maintaining a cache of previously viewed television content, including: a processor coupled to memory for receiving an input of information in addition to the content and related to the television content as well as from the cache and providing an on-screen menu to a viewer, the on-screen menu providing fields of relevant data from at least one of the additional information and the cache and receiving input from the viewer for saving at least the additional information to the cache.

A television system including: a system for maintaining a cache of previously viewed television content, including a processor in one of a smart card and a controller, the processor coupled to memory in one of the smart card, the controller and a removable drive, the processor for receiving an input of information in addition to the content and related to the television content as well as from the cache and providing an on-screen menu to a viewer, the on-screen menu providing fields of relevant data including at least one of a title, a duration, a listing of actors, a year of production, a rating, a type of content and a summary from at least one of the additional information and the cache and receiving input from the viewer for saving at least the additional information to the cache.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product for maintaining a cache of previously viewed television content is provided, and includes instructions for: receiving an input of information in addition to and related to the television content as well as from the cache; providing an on-screen menu to a viewer, the on-screen menu providing fields of relevant data from at least one of the additional information and the cache; and receiving input from the viewer for saving at least the additional information to the cache. The computer program further makes use of at least one of a smart card and a controller of the system and a removable media; the on-screen menu includes information regarding up to ten previously viewed shows; the additional information includes at least one of a title, a duration, a listing of actors, a year of production, a rating, a type of content and a summary; and the program further provides for selecting a channel for viewing and storing the cache in memory.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a television set according to the teachings herein;

FIG. 2 illustrates one example of an apparatus for distributing content; and

FIG. 3 illustrates one example of a method for using the system.

The detailed description explains the preferred embodiments of the invention, together with advantages and features, by way of example with reference to the drawings.

### DETAILED DESCRIPTION OF THE INVENTION

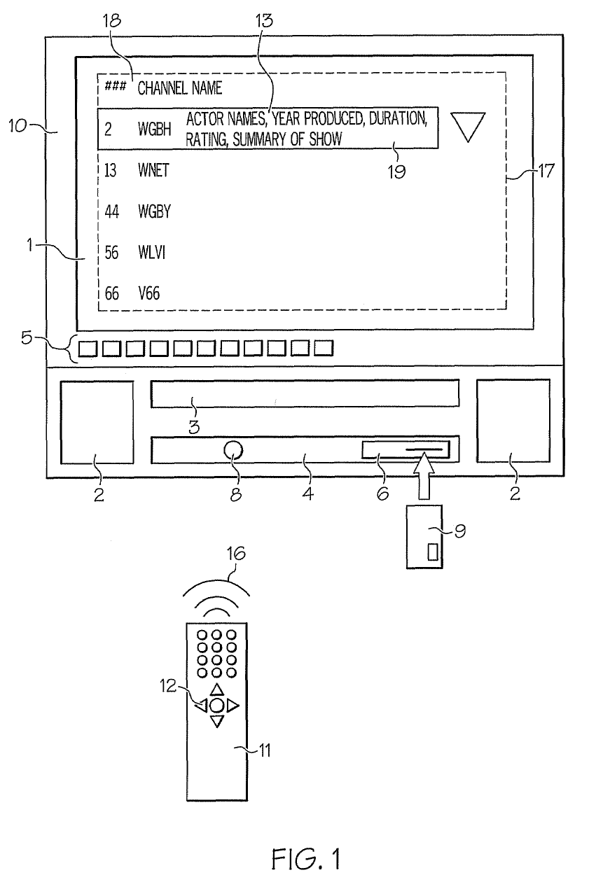

Referring now to FIG. 1, there is shown an exemplary television system 10 according to the teachings herein. The television system 10 includes components such as a display 1, a tuner 3, speakers 2 and controls 5. The components provide for functionality of the television system 10 as is known in the art. Also included in the television system 10 is a controller 4. The controller 4 provides for, among other things, certain enhanced function as disclosed herein. For example, in one embodiment, the controller 4 includes a smart card reader 6 for reading a smart card 9. Other types of media and processing capabilities may be used in place of or in addition to the smart card 9. Accordingly, the smart card 9 is merely exemplary and non-limiting of the teachings herein. As used herein, the term “smart card” makes reference to known technologies including processing capabilities as well as memory on a removable media. A variety of formats are known to exist, any of which may be used with the teachings herein.

Of course, some components, such as the tuner 3 may actually be separate from the television system 10. Accordingly, a television system 10 including a tuner 3 is merely illustrative of the teachings herein, and is not limiting in any way. Other exemplary embodiments include systems 10 having a processor on board, with a reader 6 for memory (such as a Universal Serial Bus (USB) removable drive).

As disclosed herein, the teachings provide for a menuing system (or menu system) that is used in conjunction with the television system 10.

Typically, the system 10 includes a receiver 8 for receiving a signal 16 from a remote control 11. The remote control 11 includes various selection devices 12 for selecting options. Exemplary processes for selecting options include selecting from an on-screen menu 18. The on-screen menu 18 typically includes various features such as a selector for highlighting a focus of the controller 4. In some embodiments, the selector provides a window 19 for viewing more detailed information about a particular selection.

Typically, the smart card 9 provides processing capabilities, memory and other computational power needed for providing viewers with an ability to view the last several channels watched on the television system 10. This in contrast to the currently limited options available, such as those using a “last” button on a remote control (wherein the “last” button will return the viewer to the last channel viewed).

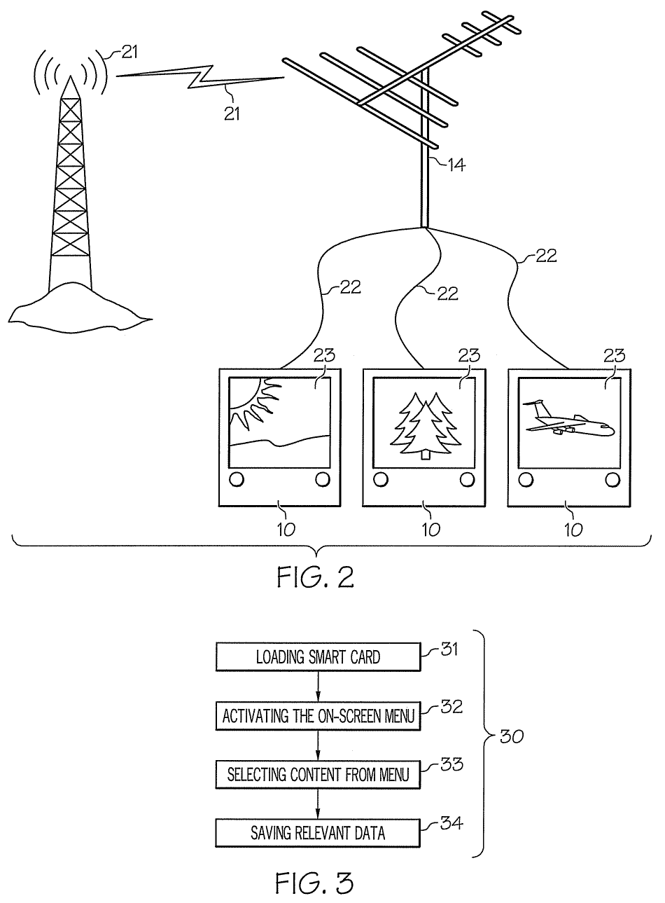

Referring now to FIG. 2, there is shown an exemplary distribution apparatus for providing content 23. In this embodiment, the content 23 is provided via a signal 21. The signal 21 is provided to each system 10 via an input 22. In this example, the input 22 includes a cable coupled to an antenna 14. The antenna 14 receives the signal 21 generated by a broadcaster. The broadcaster provides multiple signals 21 thereby providing users with multiple streams of content 23. Each stream of content 23 is viewed on separate channels of each system 10. In some embodiments, the broadcasters provide additional information with the signal 21 regarding the content 23. The additional information may include various items of interest, such as is provided in prior art guides (for example, information such as a title, a duration, a listing of actors, a year of production, a rating, a type of content, a summary, etc, . . . ).

In typical embodiments, there is a smart card reader 6 installed into the system 10. However, in other embodiments, the reader 6 may be included in a set-top box, such as one of a satellite box and a cable box. The combination of the reader 6, the smart card 9 and the controller 4 provide the system 10 with capabilities for listing a plurality of recently viewed channels. For example, the system 10 may provide for quick referencing to the last ten (10) channels.

In the example depicted in FIG. 1, the on-screen menu 18 provides a scrolling menu for scrolling through the plurality of recently viewed channels. In other embodiments, the system 10 provides a pull-down screen listing the last several channels viewed. The user will have the option of specifying the maximum number of channels viewed for review in the menu 18. Typically, the menu 18 is invoked by pushing a single button on the remote control 11.

The system 10 provides users with a “Quick Browse” (QB) option. When selected, the QB option, will typically provide an overlay 17 on the screen, wherein the overlay 17 contains the selected number of channels for which users may browse.

Typically, the menu 18 for the ‘QB’ selection will provide a program name, a time a show is being offered. The system 10 provides an option to display more about each show, once a corresponding menu item is highlighted. Highlighting occurs, for example, by the viewer using scroll up and down arrow keys of the selection devices 12.

In typical embodiments, the viewer is provided with an option for one of scrolling up and down a list of recently viewed channels to select a program for viewing or just keying in the selection number which contains the channel and the show viewed or selecting the actual channel for the show the end user wishes to view.

In some embodiments, if the end user wants to maintain a list of programs that were selected within the last twenty four (24) hours (using a full day—12:00 A.M. to 11:59 P.M.), the information will be provided by the menu 18. However, in these embodiments, the user will not be able to select the channel for viewing. For example, the user will only be able to get the name, the program menu and the time last shown.

The teachings herein provide for pulling out (i.e., separating) fields of relevant data 13 from the additional information. The fields of relevant data 13 are placed into another window 19 so the viewer is not bombarded with excessive data. Aspects of the window 19 are customizable and provides the user with the option to see only the relevant data 13 they are interested in seeing. The window 19 provides accessibility to quick and easy navigation to connect to the channel the viewer desires.

This is different from a ‘FAV’ (favorites) option which currently exists but only provides users with an option to save channels. That is, the favorites option does not permit a user to save a specific program on a specified channel to a listing. This teachings herein allow the viewer to save information about a specific show or shows and access that show providing that it is currently playing.

This invention also provides for creation of an archive list, where the list is of all the shows viewed in the last 24 hour period (12:00 A.M.-11:59 P.M.). Typically, the system 10 maintains a temporal parity with a guide menu provided with the content (such as by a cable provider). This feature offers a viewer the option of knowing what television shows were previously viewed for reasons such as simply knowing or being reminded of television show that previously aired. Further, this feature provides adults with information regarding whether a child may have watched an inappropriate channel.

Typically, the QB window is populated by pulling in fields of relevant data 13 taken from the additional information. The QB window will include a listing for the currently viewed program (by default) or an explicitly selected program. The information contained in the cached QB window would be the name of the program, date, time, description and channel. Other information may be included.

Each viewer will have an option of saving program information. At least two techniques are provided for saving the information. First, when channel surfing, if the viewer sees a television program on a channel he or she might like to come back to, the viewer is provided with an option to save that information to the QB window. This will be accomplished by selecting a save option which may be button (for example, an A, B, C selection on the guide screen). Other techniques may be provided. For example, additional on-screen features may be provided, as well as additional features on the remote control 11. A second technique for saving program information is realized by viewing the program and then saving the program information to the QB screen at the viewer's discretion.

In some embodiments, the QB window also provides the end user the capability to save a show that will be aired in the future. For example, a show currently scheduled for airing in one hour could be saved. The information is saved to the QB window so the end user can then decide to view if they chose to do so. In these embodiments, the QB window keeps a running log for the show during the entire duration that the show is being aired or until the end user decides to delete it from the window.

Some embodiments of the teachings herein take advantage of the removable nature of the smart card 9. Accordingly, the teachings also provide for recognition of different broadcasting arrangements and content distribution schemes. In further embodiments, the smart card provides for establishing a parity between one distribution scheme and another. For example, one might wish to take the smart card 9 along when leaving home and visiting relatives. In this case, where the relatives reside within the service area of another broadcaster, the smart card 9 (and the system 10) are equipped to correlate shows within the differing channel arrangements of each broadcaster.

A method for using a menu system 30 (as taught herein) calls for loading the smart card 31, activating the on-screen menu 32 and selecting content from the menu 33. Optionally, the method for using the menu system 30 provides for saving relevant data 34 to a cache for populating the on-screen menu 18.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A menu system for maintaining a cache of previously viewed television content, comprising:
a processor coupled to memory for receiving an input of information in addition to the content and related to the television content as well as from the cache and providing an on-screen menu to a viewer, the on-screen menu providing fields of relevant data from at least one of the additional information and the cache and receiving input from the viewer for saving at least the additional information to the cache.

2. The menu system as in claim 1, wherein the processor is comprised within one of a smart card and a controller of the system.

3. The menu system as in claim 1, wherein the memory is comprised within one of a smart card, a controller of the system and a removable media.

4. The menu system as in claim 1, wherein the on-screen menu comprises information regarding up to ten previously viewed shows.

5. The menu system as in claim 1, wherein the additional information comprises at least one of a title, a duration, a listing of actors, a year of production, a rating, a type of content and a summary.

6. The menu system as in claim 1, wherein the system further comprises instructions for selecting a channel according to a selection by the viewer.

7. A computer program product stored on machine readable media and providing machine executable instructions for maintaining a cache of previously viewed television content, the instructions comprising instructions for:
receiving an input of information in addition to and related to the television content as well as from the cache;
providing an on-screen menu to a viewer, the on-screen menu providing fields of relevant data from at least one of the additional information and the cache; and
receiving input from the viewer for saving at least the additional information to the cache.

8. The computer program product as in claim 7, wherein the media comprises at least one of a smart card and a controller of the system and a removable media.

9. The computer program product as in claim 7, wherein the on-screen menu comprises information regarding up to ten previously viewed shows.

10. The computer program product as in claim 7, wherein the additional information comprises at least one of a title, a duration, a listing of actors, a year of production, a rating, a type of content and a summary.

11. The computer program product as in claim 7, further comprising instructions for selecting a channel for viewing.

12. The computer program product as in claim 7, further comprising instructions for storing the cache in the memory.

13. A television system coupled to a menu system for maintaining a cache of television content, the menu system comprising:
a processor in one of a smart card and a controller, the processor coupled to memory in one of the smart card, the controller and a removable drive, the processor for receiving an input of information in addition to the content and related to the television content as well as from the cache and providing an on-screen menu to a viewer, the on-screen menu providing fields of relevant data comprising at least one of a title, a duration, a listing of actors, a year of production, a rating, a type of content and a summary from at least one of the additional information and the cache and receiving input from the viewer for saving at least the additional information to the cache.

14. The television system as in claim 13, wherein the menu system is comprised within one of a set-top box, a satellite box and a cable box.

15. The television system as in claim 13, wherein the menu system is provided by a television service provider.
